(19) United States
(12) Patent Application Publication
(10) Pub. No.: US 2025/0378402 A1
(43) Pub. Date: Dec. 11, 2025

(54) DEMAND PREDICTION DEVICE, DEMAND PREDICTION SYSTEM, AND DEMAND PREDICTION MANAGEMENT METHOD

(71) Applicant: Hitachi, Ltd., Tokyo (JP)

(72) Inventors: Shouchun PENG, Tokyo (JP); Rieko OTSUKA, Tokyo (JP)

(21) Appl. No.: 19/209,558

(22) Filed: May 15, 2025

(30) Foreign Application Priority Data
Jun. 6, 2024 (JP) 2024-091905

(51) Int. Cl. G06Q 10/0631; G06N 3/0464; G06Q 50/40

(52) U.S. Cl. CPC G06Q 10/06315; G06N 3/0464; G06Q 50/40

(57) ABSTRACT

A demand prediction device includes an index management unit configured to apply a predetermined spatial index unit to first area information to generate a first spatial index, a training information management unit configured to analyze the first spatial index and first travel route information to generate, for a first period, first people flow information indicating a people flow in a first area, a model training unit configured to train a graph neural network using people flow information and the first area information as training information to generate a trained demand prediction model, and a prediction unit configured to process, by the trained demand prediction model, second area information characterizing a target location in a second area and second people flow information indicating a people flow in the second area to generate, for a second period, demand prediction information indicating a demand degree for each target location in the second area.

### CROSS-REFERENCE TO RELATED APPLICATIONS

The present application claims priority to Japanese Patent Application No. 2024-091905, filed Jun. 6, 2024. The contents of this application are incorporated herein by reference in their entirety.

### TECHNICAL FIELD

The present disclosure relates to a demand prediction device, a demand prediction system, and a demand prediction management method.

### BACKGROUND ART

With diversification of transportation modes, transportation companies, commercial companies, urban planning businesses, and the like are required to accurately grasp transportation patterns of people to provide services that meet demands and alleviate demands.

In recent years, a machine learning model may be used as a unit that predicts a demand for a transportation service. By using the machine learning model, it is possible to estimate a future demand based on past demand information or the like of the transportation service.

For example, there is WO2021/174755 (PTL 1) as a unit that predicts a demand for a rail transit service.

PTL 1 discloses that “the present disclosure provides a rail transit passenger flow demand prediction method and apparatus based on deep learning. The prediction method includes the following steps: acquiring OD data, and converting the OD data into periodic OD two-dimensional graph sequence data; inputting the periodic OD two-dimensional graph sequence data to a spatial complex-associated convolutional residual network model, and outputting spatial feature data; inputting the spatial feature data to a time feature information extraction model, and outputting time feature data; and performing feature extraction using the time feature data to acquire an OD passenger flow value at a prediction moment. The prediction method is evaluated as necessary. According to this method, a predicted OD passenger flow value at a prediction moment is obtained by analyzing multi-period association of the OD data and extracting feature data, and thus prediction accuracy is high.”.

### SUMMARY OF INVENTION

### Technical Problem

PTL 1 describes a unit that predicts a demand for a rail transit service based on so-called Origin/Destination (OD) data by using a convolutional neural network (CNN).

According to the unit described in PTL 1, it is possible to predict a demand for the rail transit service, but it is not assumed to predict demand in any place such as an event venue, a building, or a public facility. In addition, in the convolutional neural network used in PTL 1, since it is difficult to grasp a relation existing between elements such as a feature of an area, a demand for each time, and a traveler transportation preference, it is difficult to generate a robust prediction, and prediction accuracy for a fine time interval (for example, 15 minutes or 30 minutes) may be limited.

Therefore, an object of the present disclosure is to provide a demand prediction unit capable of generating a highly accurate prediction regarding a demand status of a specific area by training a graph neural network using training data based on a feature of an area which is a prediction target, a demand for each time, a traveler transportation preference, and the like.

### Solution to Problem

In order to solve the above problems, a representative demand prediction device according to the invention includes: a processor; a memory; and a storage unit, and the storage unit stores first area information characterizing a target location in a first area, and first travel route information characterizing a travel route of a traveler moving in the first area, and the memory includes a processing instruction for causing the processor to execute as an index management unit configured to apply a predetermined spatial index unit to the first area information to generate a first spatial index indicating the first area information in a hierarchical structure, a training information management unit configured to analyze the first spatial index and the first travel route information to generate, for a first period, first people flow information indicating a people flow in the first area, a model training unit configured to train a graph neural network using at least the first people flow information and the first area information as training information to generate a trained demand prediction model, and a prediction unit configured to process, by the trained demand prediction model, second area information characterizing a target location in a second area and second people flow information indicating a people flow in the second area to generate, for a second period, demand prediction information indicating a demand degree for each target location in the second area.

### Advantageous Effects of Invention

According to the present disclosure, it is possible to provide a demand prediction unit capable of generating a highly accurate prediction regarding a demand status of a specific area by training the graph neural network using the training data based on a feature of an area which is a prediction target, a demand for each time, a traveler transportation preference, and the like.

Problems, configurations, and effects other than those described above will be made clear by the following description of embodiments for carrying out the invention.

### BRIEF DESCRIPTION OF DRAWINGS

FIG. 1 is a diagram illustrating a computer system for implementing an embodiment of the present disclosure.

FIG. 2 is a diagram illustrating an example of a configuration of a demand prediction system according to the embodiment of the present disclosure.

FIG. 3 is a diagram illustrating an example of a flow of people flow information generation processing according to the embodiment of the present disclosure.

FIG. 4 is a diagram illustrating an example of a flow of training processing according to the embodiment of the present disclosure.

FIG. 5 is a diagram illustrating an example of a demand management screen according to the embodiment of the present disclosure.

FIG. 6 is a diagram illustrating an example of a configuration of travel route information according to the embodiment of the present disclosure.

FIG. 7 is a diagram illustrating an example of a configuration of passage record information according to the embodiment of the present disclosure.

FIG. 8 is a diagram illustrating an example of a configuration of transportation mode information according to the embodiment of the present disclosure.

FIG. 9 is a diagram illustrating an example of area information according to the embodiment of the present disclosure.

FIG. 10 is a diagram illustrating an example of a configuration of building feature information according to the embodiment of the present disclosure.

FIG. 11 is a diagram illustrating an example of a configuration of weather information according to the embodiment of the present disclosure.

FIG. 12 is a diagram illustrating an example of information in a spatial index according to the embodiment of the present disclosure.

FIG. 13 is a diagram illustrating an example of a distance matrix according to the embodiment of the present disclosure.

FIG. 14 is a diagram illustrating an example of people flow information according to the embodiment of the present disclosure.

### DESCRIPTION OF EMBODIMENTS

Hereinafter, the embodiments of the invention will be described with reference to the drawings. The invention is not limited to the embodiments. In the description of the drawings, the same portions are denoted by the same reference signs.

Terms “first”, “second”, “third”, and the like may be used to describe various elements or components in the present disclosure, and it will be understood that these elements or components are not to be limited by these terms. These terms are used only to distinguish between one element or component from another element or component. Therefore, a first element or a component described below may be referred to as a second element or a component without departing from the teaching of the concept of the invention.

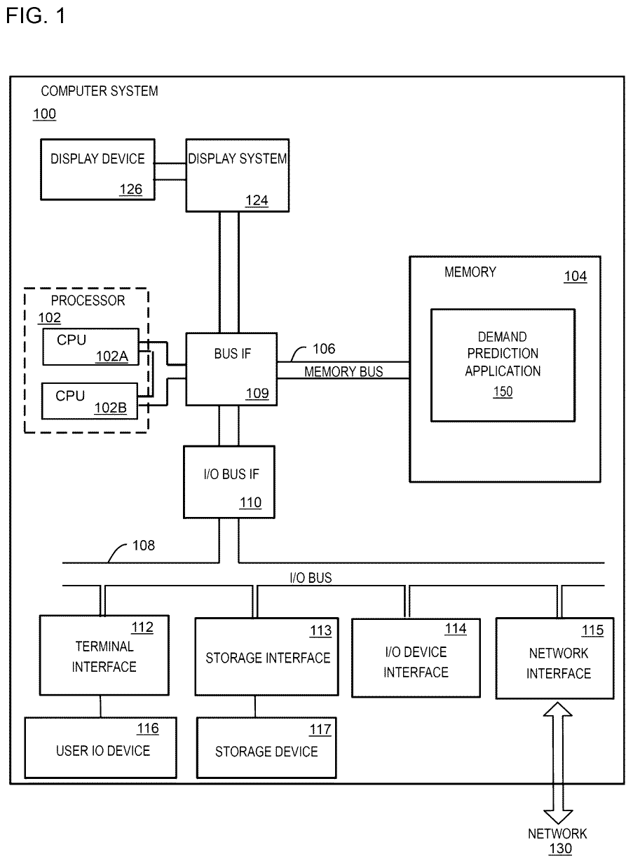

Next, a computer system 100 for implementing the embodiment of the present disclosure will be described with reference to FIG. 1. Mechanisms and devices of various embodiments disclosed in the description may be applied to any appropriate computing system. Main components of the computer system 100 include one or more processors 102, a memory 104, a terminal interface 112, a storage interface 113, an input and output (I/O) device interface 114, and a network interface 115. These components may be mutually connected via a memory bus 106, an I/O bus 108, a bus interface unit 109, and an I/O bus interface unit 110.

The computer system 100 may include one or more general purpose programmable central processing units (CPUs) 102A and 102B, collectively referred to as the processor 102. In one embodiment, the computer system 100 may include a plurality of processors, or in another embodiment, the computer system 100 may be a single CPU system. Each of the processors 102 may execute an instruction stored in the memory 104 and include an on-board cache. In one embodiment, the computer system 100 may include a graphics processing unit (GPU) in addition to the processor 102. By using the GPU, it is possible to speed up processing of a machine learning model or the like used in a demand prediction application 150 to be described later.

In one embodiment, the memory 104 may include a random access semiconductor memory for storing data and programs, a storage device, or a storage medium (either volatile or nonvolatile). The memory 104 may store all or some of a program, a module, and a data structure for implementing functions described in the description. For example, the memory 104 may store the demand prediction application 150. In one embodiment, the demand prediction application 150 may include an instruction or a description for executing a function described later on the processor 102.

In one embodiment, the demand prediction application 150 may be implemented by hardware via a semiconductor device, a chip, a logic gate, a circuit, a circuit card, and/or another physical hardware device, instead of a processor-based system or in addition to the processor-based system. In one embodiment, the demand prediction application 150 may include data other than the instruction or the description. In one embodiment, a camera, a sensor, or another data input device (not illustrated) may directly communicate with the bus interface unit 109, the processor 102, or other hardware of the computer system 100.

The computer system 100 may include the bus interface unit 109 that performs communication between the processor 102, the memory 104, a display system 124, and the I/O bus interface unit 110. The I/O bus interface unit 110 may be coupled to the I/O bus 108 for transferring data to and from various I/O units. The I/O bus interface unit 110 may communicate with the plurality of I/O interface units 112, 113, 114, and 115 which are known as an I/O processor (IOP) or an I/O adapter (IOA) via the I/O bus 108.

The display system 124 may include a display controller, a display memory, or both. The display controller can provide video, audio, or data of the video and audio to a display device 126. The computer system 100 may include one or a plurality of devices such as sensors implemented to collect data and provide the data to the processor 102.

For example, the computer system 100 may include a biometric sensor that collects heart rate data, stress level data, and the like, an environmental sensor that collects humidity data, temperature data, pressure data, and the like, and a motion sensor that collects acceleration data, movement data, and the like. Sensors of other types can also be used. The display system 124 may be connected to the display device 126 such as a stand-alone display screen, a television, a tablet, or a portable device.

The I/O interface unit has a function of communicating with various storages or I/O devices. For example, a user I/O device 116, such as a user output device such as a video display device or a speaker television, or a user input device such as a keyboard, a mouse, a keypad, a touch pad, a track ball, a button, a light pen, or another pointing device, can be attached to the terminal interface unit 112. A user may use a user interface to operate a user input device to enter input data and instructions to the user I/O device 116 and the computer system 100, and to receive output data from the computer system 100. The user interface may be displayed on a display device, played through a speaker, or printed via a printer, via the user I/O device 116, for example.

One or a plurality of disk drives or a direct access storage device 117 (which is usually a magnetic disk drive storage device, but may be an array of disk drives implemented to be seen as a single disk drive or another storage device) can be attached to the storage interface 113. In one embodiment, the storage device 117 may be implemented as any secondary storage device. Contents of the memory 104 are stored in the storage device 117, and may be read from the storage device 117 as necessary. The I/O device interface 114 may provide an interface for other I/O devices such as a printer and a fax machine. The network interface 115 may provide a communication path so that the computer system 100 and other devices can communicate with each other. The communication path may be, for example, a network 130.

In one embodiment, the computer system 100 may be a device that receives a request from another computer system (client) without a direct user interface, such as a multi-user mainframe computer system, a single user system, or a server computer. In another embodiment, the computer system 100 may be a desktop computer, a portable computer, a notebook computer, a tablet computer, a pocket computer, a telephone, a smartphone, or any other appropriate electronic device.

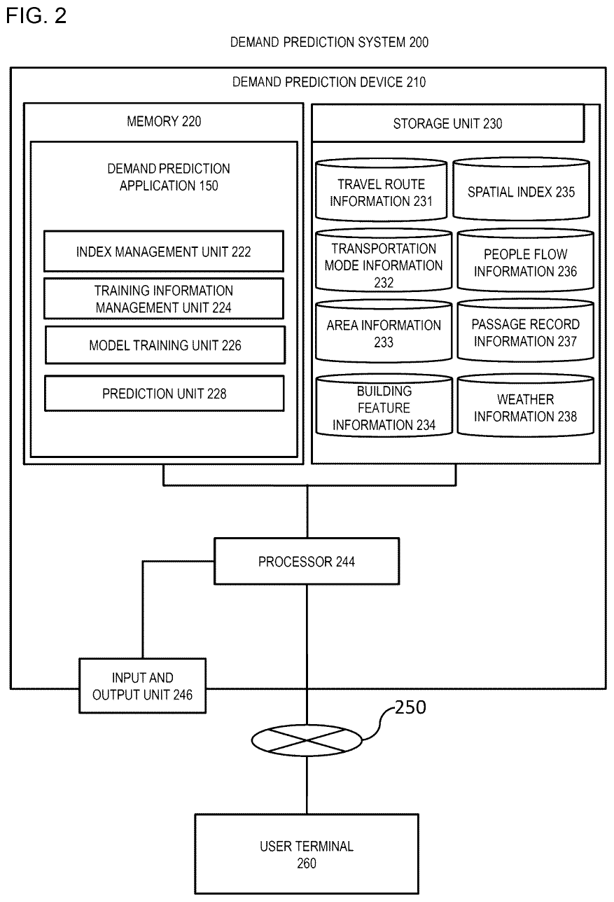

Next, a demand prediction system according to the embodiment of the present disclosure will be described with reference to FIG. 2.

FIG. 2 is a diagram illustrating an example of a configuration of a demand prediction system 200 according to the embodiment of the present disclosure. The demand prediction system 200 according to the embodiment of the present disclosure is a system for generating a highly accurate prediction for a demand status of a specific prediction target area, and mainly includes a demand prediction device 210 and a user terminal 260 as illustrated in FIG. 2. The demand prediction device 210 and the user terminal 260 may be connected to each other via a communication network 250.

The demand prediction device 210 is a device for generating a highly accurate prediction for the demand status of the specific prediction target area, and mainly includes a memory 220, a storage unit 230, a processor 244, and an input and output unit 246 as illustrated in FIG. 2.

In one embodiment, the demand prediction device 210 may be implemented by the computer system 100 illustrated in FIG. 1.

The memory 220 may be a memory for storing the demand prediction application 150 that implements a function of a demand prediction unit according to the embodiment of the present disclosure. As illustrated in FIG. 2, the demand prediction application 150 may include processing instructions for implementing functions of software modules such as an index management unit 222, a training information management unit 224, a model training unit 226, and a prediction unit 228.

The index management unit 222 is a functional unit that generates a spatial index for a predetermined area. For example, by applying a spatial index unit such as an R-tree index unit to area information 233 (for example, first area information) indicating geographic coordinates of a target location in a specific area (for example, a first area), the index management unit 222 may generate a spatial index 235 indicating the area information 233 in a hierarchical structure. In one embodiment, the spatial index 235 may define a space relation of target locations and a determination region for each of the target locations.

Details of a function of the index management unit 222 will be described later, and a description thereof will be omitted here.

The training information management unit 224 analyzes the spatial index 235 generated by the index management unit 222 and travel route information 231 indicating a travel route of a traveler moving in a specific area (for example, the first area) to generate people flow information 236 indicating a people flow in the area. The training information management unit 224 may generate transportation preference information indicating a priority order of transportation modes for the travel route of the traveler moving in the specific area by analyzing transportation mode information 232 indicating a transportation mode used by the traveler by a predetermined statistical analysis unit, for each travel route of the traveler. As will be described later, the area information 233 and the people flow information 236 are a part of training information used for training a graph neural network.

Details of a function of the training information management unit 224 will be described later, and thus a description thereof will be omitted here.

The model training unit 226 generates a trained demand prediction model by training the graph neural network using at least the area information 233 and the people flow information 236 as the training information. In one embodiment, the model training unit 226 may train the graph neural network using, as the training information, transportation preference information generated based on building feature information 234, weather information 238, and the transportation mode information 232, which will be described later, in addition to the area information 233 and the people flow information 236. Here, in order to train the graph neural network, the model training unit 226 may use predetermined deep learning training unit or reinforcement learning unit.

Details of a function of the model training unit 226 will be described later, and thus a description thereof will be omitted here.

The prediction unit 228 uses the graph neural network trained by the model training unit 226 to process area information (second area information) characterizing a target location in a specific area (for example, a second area) and travel route information (second travel route information) characterizing a travel route of a traveler moving in the area, thereby generating demand prediction information indicating a demand degree for each target location in the area for a predetermined period.

Details of a function of the prediction unit 228 will be described later, and thus a description thereof will be omitted here. The information input to the prediction unit 228 is not limited to the area information and the travel route information, and the building feature information 234 and the weather information 238 to be described later may be analyzed. Accordingly, it is possible to generate demand prediction information in consideration of an influence of more pieces of information on the demand degree.

The storage unit 230 is a storage region for storing various types of information according to the embodiment of the present disclosure, and may include the travel route information 231, the transportation mode information 232, the area information 233, the building feature information 234, the spatial index 235, the people flow information 236, passage record information 237, and the weather information 238 as illustrated in FIG. 2.

The travel route information 231 is information indicating a travel route of a traveler moving in a specific area.

The transportation mode information 232 is information indicating a transportation mode used by the traveler moving in the specific area for each travel route of the traveler.

The area information 233 is information characterizing a target location in the specific area.

The building feature information 234 is information characterizing a feature of a building in the specific area. The spatial index 235 is information indicating a space relation of target locations in the specific area in a hierarchical structure.

The people flow information 236 is information indicating a people flow in the specific area.

The passage record information 237 is information indicating a travel route that passes through a determination region for the target location defined in the spatial index 235.

The weather information 238 is information characterizing a climate of the specific area.

Details of the various types of information stored in the storage unit 230 will be described later, and thus a description thereof will be omitted here.

The processor 244 is a processing unit that executes a processing instruction that defines the function of the functional unit in the demand prediction application 150 stored in the memory 220.

The input and output unit 246 is a functional unit that receives information input to the demand prediction device 210 and outputs information (demand prediction information or the like) generated by the demand prediction device 210. In one embodiment, the input and output unit 246 may include, for example, a keyboard, a mouse, or a display that displays a graphical user interface (GUI). In one embodiment, the input and output unit 246 may provide the user terminal 260 with an GUI for inputting and outputting various types of information.

The communication network 250 may include, for example, a local area network (LAN), a wide area network (WAN), a satellite network, a cable network, a WiFi network, or any combination thereof.

The user terminal 260 is a terminal device that can be used by a user of the demand prediction device 210. The user can use the user terminal 260 to check the demand prediction information output from the demand prediction device 210. As an example, the user terminal 260 may include, but is not particularly limited to, for example, a smartphone, a smartwatch, a tablet, or a personal computer of a user who subscribes to the demand prediction service provided by the demand prediction system 200.

In FIG. 2, for convenience of description,, a configuration including one user terminal 260 is described as an example, but the number of user terminals 260 is not limited, and a configuration including a plurality of user terminals 260 is also possible.

According to the demand prediction system 200 in the present disclosure described above, it is possible to generate a highly accurate prediction regarding a demand status of a specific area.

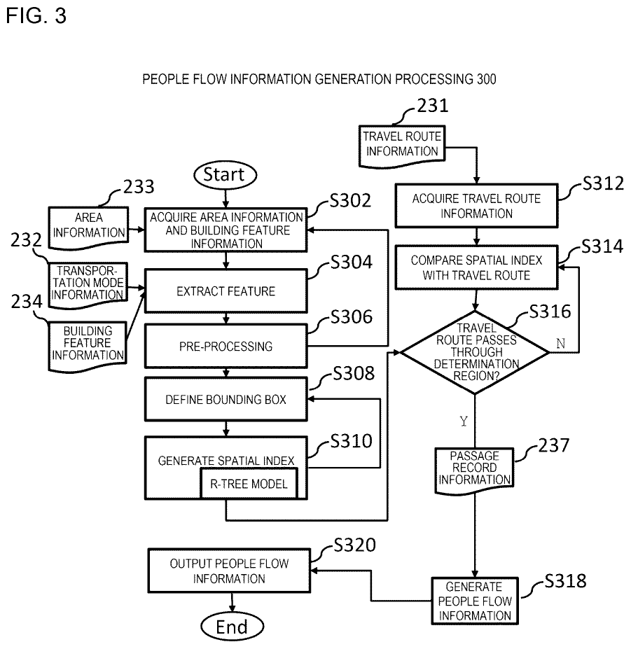

Next, people flow information generation processing according to the embodiment of the present disclosure will be described with reference to FIG. 3.

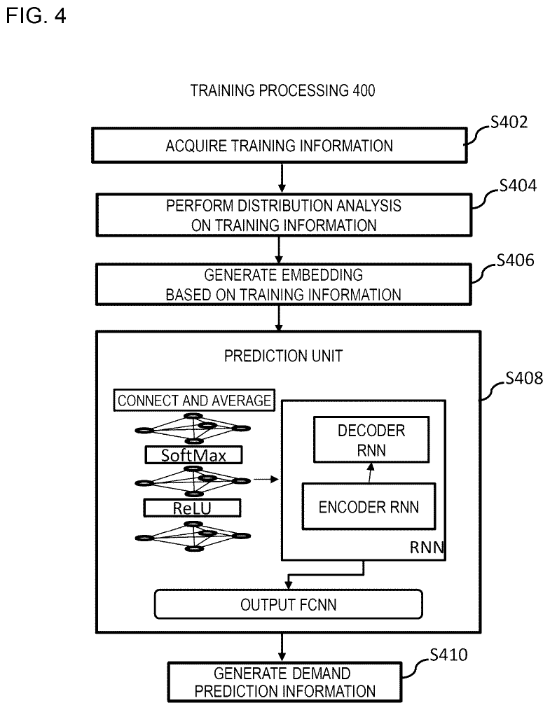

FIG. 3 is a diagram illustrating an example of a flow of people flow information generation processing 300 according to the embodiment of the present disclosure. The people flow information generation processing 300 illustrated in FIG. 3 is processing for generating the people flow information 236 indicating a people flow in a specific area, and is executed by the training information management unit 224 illustrated in FIG. 2. As will be described later, the people flow information 236 generated by the people flow information generation processing 300 is used in training processing 400 illustrated in FIG. 4 to train a graph neural network that generates demand prediction information.

First, in step S302, the training information management unit 224 acquires the area information 233 characterizing a target location in a specific area from information stored in the storage unit 230, and generates a mathematical expression for each of the target locations in the area information 233. Here, the target location may be any place present in the area information, and may include, for example, a railway station, a bus stop, a public facility, a park, a building, a structure, and an indoor region (room) in the building. In one embodiment, the training information management unit 224 may generate a mathematical expression as illustrated in the following mathematical formula 1 for each of the target locations in the area information 233.

$${OBJ}_{i} = ( I D , Location ID , BBX , Postlist , Usage ) \qquad [ Math . 1 ]$$

Here, the ID is an ID for uniquely identifying a target location, the LocationID is an ID for uniquely identifying an area where the target location is present, the BBX is information defining a determination region (bounding box) including the target location, the Postlist is a position defined by latitude and longitude of the target location, and the Usage is information indicating use (commercial, transportation, administration, or the like) of the target location.

According to this mathematical expression, in a 3D model, a target location in the area can be represented as a solid 3D object.

Next, in step S304, the training information management unit 224 acquires the transportation mode information 232 indicating a transportation mode used by a traveler moving in the specific area and the building feature information 234 characterizing a feature of a building in the specific area, for each travel route of the traveler from information stored in the storage unit 230, and extracts a feature from the transportation mode information 232, the area information 233, and the building feature information 234, thereby extracting features such as a position (latitude and longitude), a feature (the number of floors, a height, and an owned area), and an inner structure (a layout of an indoor region) of a building (a high-rise building, a station, a restaurant, a house, or the like) in the specific area.

Next, in step S306, the training information management unit 224 executes pre-processing for the feature extracted in step S304. Here, the training information management unit 224 may execute pre-processing such as transpose, data cleansing or filtering for deleting duplicate information or unrelated data for the extracted feature. In one embodiment, the training information management unit 224 may convert a feature subjected to pre-processing into a graph representation. In this graph representation, the target location in the area information 233 may be represented as a node, the travel route of the traveler may be represented as an edge between the nodes, and other features may be represented as node information associated with the node or edge information associated with the edge.

The training information management unit 224 may return to step S302 and repeat subsequent processing until the pre-processing for all the features is completed.

Next, in step S308, the training information management unit 224 defines a determination region for each of the target locations in the area information 233. The determination region here is a region having a certain size including the target location, and may define, for example, a region within a predetermined distance (1 kilometer, 5 kilometers, or the like) from the target location. As will be described later, by comparing this determination region with the travel route of the traveler in the travel route information 231, it is possible to determine a people flow for each target location.

In one embodiment, the training information management unit 224 may draw the determination region determined here as a bounding box on a map or a 3D model indicating the area.

Next, in step S310, the training information management unit 224 uses a predetermined spatial index unit to generate the spatial index 235 indicating a space relation of the target locations based on geographic coordinates of the target location in the area information 233, the feature extracted in step S304, the determination region determined in step S308, and the like. As an example, when the spatial index 235 is generated using, for example, the R-tree index unit, the geographic coordinates of the target location in the area information 233, the feature extracted in step S304, the determination region determined in step S308, and the like are represented as nodes or leaves of a tree structure.

As described above, the spatial index 235 is information indicating the space relation of the target locations in the specific area in a hierarchical structure, and may be any of a table form, a 2D map, and a 3D model. By comparing the determination region for the target location defined in the spatial index 235 with the travel route of the traveler in the travel route information 231, a people flow for each target location can be determined.

By constructing the spatial index 235 based on features such as the position (latitude and longitude), the feature (the number of floors, the height, and the owned area), and the inner structure (the layout of the indoor region) of the building (the high-rise building, the station, the restaurant, the house, or the like) extracted in step S304, it is possible to generate a data structure that finely indicates the feature of the building in the specific area.

Next, in step S312, the training information management unit 224 acquires the travel route information 231 from the information stored in the storage unit 230.

Next, in step S314, the training information management unit 224 determines, for each target location in the spatial index 235 generated in step S310, whether the travel route for each traveler in the travel route information 231 acquired in step S312 passes through the determination region defined for the target location, and generates the passage record information 237 as information indicating a result of the determination. As described above, the passage record information 237 is information indicating a travel route passing through the determination region for the target location defined in the spatial index 235.

Here, the determination of whether the travel route for each traveler passes through the determination region defined for the target location may be performed by determining whether a position of a specific travel itinerary (position defined by latitude and longitude) in the travel route information 231 is in the determination region for the target location defined in the spatial index 235 for any time.

Next, in step S316, if it is determined that the travel route for the specific traveler passes through the determination region defined for any target location in the spatial index 235, the processing proceeds to step S318, and if the travel route for the specific traveler does not pass through any of the determination regions defined for the target location in the spatial index 235, the processing proceeds to the next processing. This processing is repeated until the determination regarding all the travel routes for the traveler is completed.

Next, in step S318, the training information management unit 224 analyzes the passage record information 237 generated by the determination in steps S314 to S316, and aggregate the number of people passing through each target location to generate the people flow information 236. In this way, it is possible to generate the people flow information 236 indicating the number of people staying at each target location for any time interval (15 minutes, 30 minutes) by determining whether the travel route for the traveler passes through the determination region for the target location, for each target location in the spatial index for any period, and aggregating the results.

Next, in step S320, the training information management unit 224 stores the people flow information generated in step S318 in the storage unit 230.

According to the people flow information generation processing 300 illustrated in FIG. 3, it is possible to generate people flow information indicating the number of people staying at each target location in a specific area at any time interval. As will be described later, the people flow information 236 is used as the training information for training a graph neural network for predicting demand.

More specifically, by using the spatial index 235 based on detailed features such as a position (latitude and longitude), a structure (the number of floors, a height, and an owned area), and an inner structure (a layout of an indoor region) of a building (a high-rise building, a station, a restaurant, a house, or the like) in a specific area and the travel route information 231 defining latitude and longitude of a travel route of a traveler, not only a rough demand prediction for an entire area but also a detailed demand prediction for each indoor region in the building present in the specific area can be performed.

Next, the training processing according to the embodiment of the present disclosure will be described with reference to FIG. 4.

FIG. 4 is a diagram illustrating an example of a flow of the training processing 400 according to the embodiment of the present disclosure. The training processing 400 according to the embodiment of the present disclosure is processing for training a graph neural network for predicting a demand degree for each target location in the specific area, using the training information including the people flow information 236 generated by the people flow information generation processing 300 described above, and may be performed by the model training unit 226 and the prediction unit 228 illustrated in FIG. 2.

First, in step S402, the model training unit 226 acquires the training information used for training the graph neural network. In one embodiment, the model training unit 226 may acquire, from the storage unit 230, the people flow information 236 and the area information 233 generated by the people flow information generation processing 300 described above, and use the people flow information 236 and the area information 233 as the training information. By training the graph neural network using the people flow information 236 and the area information 233 as the training information, the graph neural network is trained to learn, for any time interval, a correlation between the number of people staying at a target location in a specific area and a space relation of target locations, and generate a demand prediction for a target location in any area.

The training information according to the embodiment of the present disclosure is not limited thereto, and may include any information among the transportation preference information derived from the building feature information 234, the weather information 238, and the transportation mode information 232 in addition to the people flow information 236 and the area information 233. Accordingly, the graph neural network can be used to learn an influence of, for example, a building feature, weather, and a traveler transportation preference on the demand degree to generate a more robust demand prediction.

For example, the training information management unit 224 may generate the transportation preference information indicating a priority order of transportation modes for each travel route of the traveler moving in the specific area by analyzing the transportation mode information 232 indicating a transportation mode used by the traveler by a predetermined statistical analysis unit, for each travel route of the traveler, and may use the generated transportation preference information as the training information. Thereafter, the model training unit 226 trains the graph neural network using the transportation preference information as the training information, so that the graph neural network can learn, for any time interval, the correlation between the number of people staying at the target location in the specific area and the space relation of the target locations, and a correlation between transportation mode preferences of a user.

In one embodiment, the model training unit 226 trains the graph neural network by using, as the training information, the building feature information 234 characterizing a feature of a building in an area and the travel route information 231 indicating an indoor region of the building that is passed through on a travel route of a traveler, so that the graph neural network can be used to predict the demand degree for each region in the building for a predetermined period.

Further, in one embodiment, the model training unit 226 trains the graph neural network using, as the training information, the weather information 238 and the travel route information 231 indicating the indoor region of the building that is passed through on the travel route of the traveler, so that the graph neural network can be used to predict the demand degree in consideration of an influence of weather on the travel route of the traveler.

Next, in step S404, the model training unit 226 determines a distribution characteristic of the training information by performing a distribution analysis on the training information acquired in step S402. The distribution analysis here is processing for specifying a statistical distribution present in the training information, and may be performed by, for example, a Kolmogorov-Smirnov test. As an example, the model training unit 226 may perform the Kolmogorov-Smirnov test according to the following mathematical formula.

$${D}_{k , m} = S U {P}_{x} \vert {F}_{1 , k} ( x ) - {F}_{2 , m} ( x ) \vert \qquad [ Math . 2 ]$$

In the mathematical formula 2, F is a distribution function of training information to be tested, and SUP is a Supreme function. In one embodiment, the model training unit 226 may perform the Kolmogorov-Smirnov test on each of various types of information in the training information. By performing the Kolmogorov-Smirnov test on the training information, it is possible to determine a distribution characteristic indicating whether the training information corresponds to a normal distribution, a binomial distribution, or whether a plurality of one-dimensional probability distributions are different.

Next, in step S406, the model training unit 226 generates an embedding for the training information based on the distribution characteristic determined in step S404. Here, the embedding is information obtained by converting various types of information in the training information into a vector format that can be input to the graph neural network. More specifically, the model training unit 226 may process various types of information in the training information using a predetermined encoder to generate a vector h having a format represented by the following mathematical formula as the embedding.

$$h = [ {d}_{t - F + 1} , {d}_{t - F + 2} , … {d}_{t} ] \qquad [ Math . 3 ]$$

In the mathematical formula 3, t is time, d is a specific data point, and F is a dimension of a vector.

Thereafter, the encoder defines the following conversion matrix to convert the training information into a vector.

$${( f ( {h}_{i j} ) )}_{1 \leq i \leq m , 1 \leq j \leq n} \vert {h}_{i j} ∈ K \qquad [ Math . 4 ]$$

Here, f is a kernel function selected based on a distribution determined by the Kolmogorov-Smirnov test. As an example, the kernel function here may be defined as illustrated in a mathematical formula 5 below.

$${k}_{c} = [ {U}_{1} , … {U}_{d} ] \qquad [ Math . 5 ]$$

$${k}_{c} ∈ N \qquad [ Math . 6 ]$$

d is a dimension of a feature.

As described above, the encoder can be used to generate a K multidimensional graph embedding for the training information.

Note that, here, the model training unit 226 can generate separate embeddings for each of various types of information in the training information. For example, the model training unit 226 may generate people flow embedding information indicating the people flow information 236 in a vector format, generate area embedding information indicating the area information 233 in a vector format, and generate transportation preference embedding information indicating the transportation preference information in a vector format. In addition, the kernel function used to generate an embedding for each piece of information may be selected based on a distribution characteristic of the information.

Accordingly, it is possible to generate an appropriate embedding expression for each type of information in the training information.

Next, in step S408, the model training unit 226 trains the graph neural network using the embedding in the training information generated in step S406. Here, the model training unit 226 causes the graph neural network to generate a prediction based on the training information converted into the vector format, and updates a weight of the graph neural network to reduce a loss of the generated prediction with respect to a ground truth. Accordingly, it is possible to obtain a trained graph neural network capable of generating a demand prediction in consideration of a correlation between the number of people staying at a target location in a specific area and a space relation of target locations and a correlation between transportation mode preferences of a user, for any time interval.

Next, in step S410, the prediction unit 228 can generate demand prediction information for any area by using the trained graph neural network obtained in step S408. More specifically, area information (second area information) characterizing a target location in a specific area (second area) and people flow information (second people flow information) indicating a people flow in the area are analyzed by a trained graph neural network to generate demand prediction information indicating a demand degree for each target location in the area for a predetermined period. In one embodiment, the prediction unit 228 may determine a recommended action for controlling demand in an area (an action of sending personnel to direct a people flow, opening a spare lane, or the like) based on the generated demand prediction information, and output the recommended action together with the demand prediction information. This recommended action may be determined, for example, by comparing a demand degree predicted for a specific target location with a database indicating recommended actions associated with a demand threshold and selecting a recommended action satisfying the demand threshold.

Here, a case where the demand prediction information is generated based on the area information and the people flow information is described as an example, but the present disclosure is not limited thereto, and the trained graph neural network, for example, when trained based on the building feature information, the weather information, and the transportation preference information, may receive similar information to generate the demand prediction.

According to the training processing 400 illustrated in FIG. 4, it is possible to provide a demand prediction unit capable of generating a highly accurate prediction regarding a demand status of a specific area. More specifically, by training the graph neural network using people flow information indicating a people flow in a specific area, area information characterizing the area, and transportation preference information indicating a transportation mode preference of a traveler, it is possible for the graph neural network to learn, for any time interval, a correlation between the number of people staying at a target location in a specific area, a space relation of target locations, and transportation preferences of a traveler, and generate a demand prediction for a target location in any area.

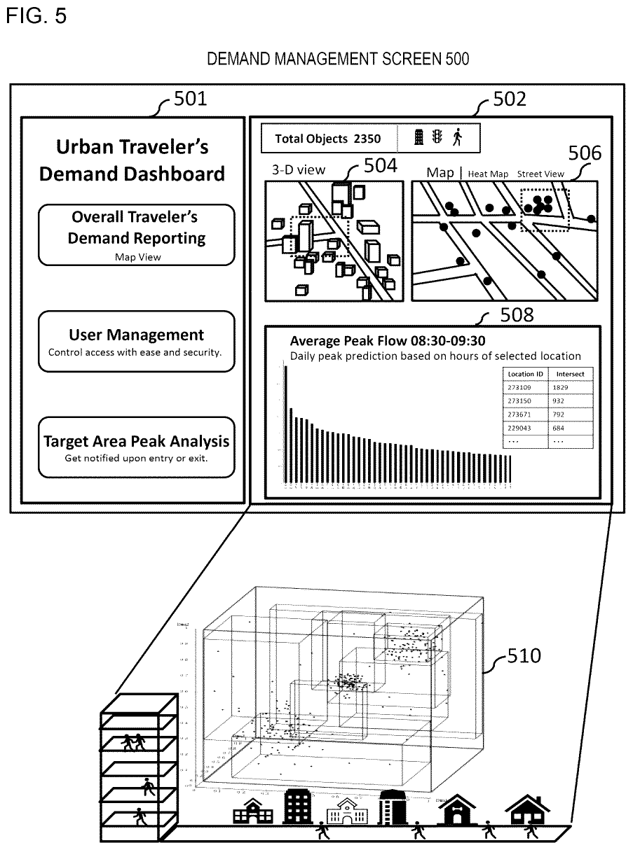

Next, a demand management screen according to the embodiment of the present disclosure will be described with reference to FIG. 5.

FIG. 5 is a diagram illustrating an example of a demand management screen 500 according to the embodiment of the present disclosure. The demand management screen 500 illustrated in FIG. 5 is a user interface screen for presenting demand prediction information generated by the demand prediction device 210 according to the embodiment of the present disclosure to the user, and may be displayed on, for example, a display of the user terminal 260 of the demand prediction system 200 illustrated in FIG. 2.

As illustrated in FIG. 5, the demand management screen 500 mainly includes an information selection menu 501 and a demand prediction display window 502.

The information selection menu 501 is a menu for selecting contents and a format of the demand prediction information displayed on the demand management screen 500, and as illustrated in FIG. 5, may include an “Overall Traveler's Demand Reporting” button indicating a demand prediction regarding an entire specific area, a “User Management” button for managing demand, and a “Target Area Peak Analysis” button indicating a peak of a demand degree for each target location in a specific area.

By selecting the “Overall Traveler's Demand Reporting” button, the user of the user terminal 260 can display, in the demand prediction display window 502, a 3D heat map 504 illustrating a demand prediction on a three-dimensional model that illustrates a target area in three dimensions or a 2D heat map 506 illustrating a demand prediction on a map that illustrates a target area in two dimensions. The 3D heat map 504 and the 2D heat map 506 are visualization graphs in which a degree of demand is indicated using color or shade. By checking the 3D heat map 504 and the 2D heat map 506, it is possible to easily grasp a demand degree predicted for each target location in an area.

In one embodiment, when the graph neural network according to the embodiment of the present disclosure is trained based on the building feature information 234 described above, structure demand expression 510 indicating a demand degree of each region in a building in a target location may be displayed in the demand prediction display window 502.

The user of the user terminal 260 can display a recommended action for controlling demand in the target area in the demand prediction display window 502 by selecting the “User Management” button. As an example, the user can confirm, as the recommended action determined for the target location exceeding a predetermined demand threshold, “Please consider sending personnel to direct people flow”, “Please consider opening spare lane”, or the like.

The user of the user terminal 260 can display a graph indicating a peak of the demand degree at a specific target location for each time in the demand prediction display window 502 by selecting the “Target Area Peak Analysis” button.

According to the demand management screen 500 described above, since the user of the user terminal 260 can easily grasp a prediction of a demand degree generated for each target location of an area and can confirm a recommended action for controlling demand, it is possible to prepare a measure to alleviate the demand at a stage before the demand actually occurs.

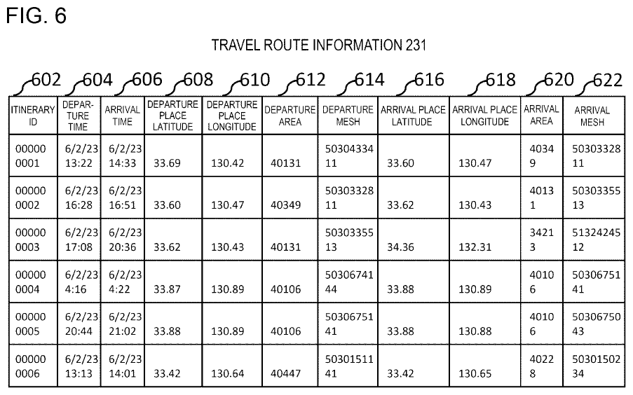

Next, the travel route information according to the embodiment of the present disclosure will be described with reference to FIG. 6.

FIG. 6 is a diagram illustrating an example of a configuration of the travel route information 231 according to the embodiment of the present disclosure. As described above, the travel route information 231 according to the embodiment 41 the present disclosure is information indicating a travel route of a traveler moving in a specific area. In one embodiment, the travel route information 231 may be information on a past use history of a user acquired by a predetermined transportation service provider, or may be acquired in advance from a transportation service provider and stored in the storage unit 230 of the demand prediction device 210.

As illustrated in FIG. 6, the travel route information 231 may include information on an itinerary ID 602, a departure time 604, an arrival time 606, a departure place latitude 608, a departure place longitude 610, a departure area 612, a departure mesh 614, an arrival place latitude 616, an arrival place longitude 618, an arrival area 620, and an arrival mesh 622.

The itinerary ID 602 is information for uniquely identifying a specific travel itinerary.

The departure time 604 is information indicating a departure time of the specific travel itinerary.

The arrival time 606 is information indicating an arrival time of the specific travel itinerary.

The departure place latitude 608 is information indicating latitude of a departure place of the specific travel itinerary.

The departure place longitude 610 is information indicating longitude of the departure place of the specific travel itinerary.

The departure area 612 is information for uniquely identifying an area from which the specific travel itinerary departs.

The departure mesh 614 is information for uniquely identifying a mesh region from which the specific travel itinerary departs, when a specific area is expressed as a mesh obtained by dividing the specific area into regions having substantially the same size.

The arrival place latitude 616 is information indicating latitude of an arrival place of the specific travel itinerary.

The arrival place longitude 618 is information indicating longitude of the arrival place of the specific travel itinerary.

The arrival area 620 is information for uniquely identifying an area where the specific travel itinerary arrives.

The arrival mesh 622 is information for uniquely identifying a mesh region from which the specific travel itinerary arrives, when a specific area is expressed as a mesh obtained by dividing the specific area into regions having substantially the same size.

For convenience of description, in FIG. 6, a case where a travel route of a traveler is indicated by latitude and longitude is described as an example, but the present disclosure is not limited thereto, and the travel route information 231 may include information on a traveler altitude in addition to the latitude and longitude. Accordingly, not only a two-dimensional position of the traveler but also a three-dimensional position can be specified, and thus, for example, it is possible to manage information (in-building movement information) regarding an indoor region (for example, “13F of a first department store”) of a building that is passed through on a travel route of a traveler.

As described above, by using the travel route information 231 according to the embodiment of the present disclosure, it is possible to predict a demand degree for each target location in a specific area.

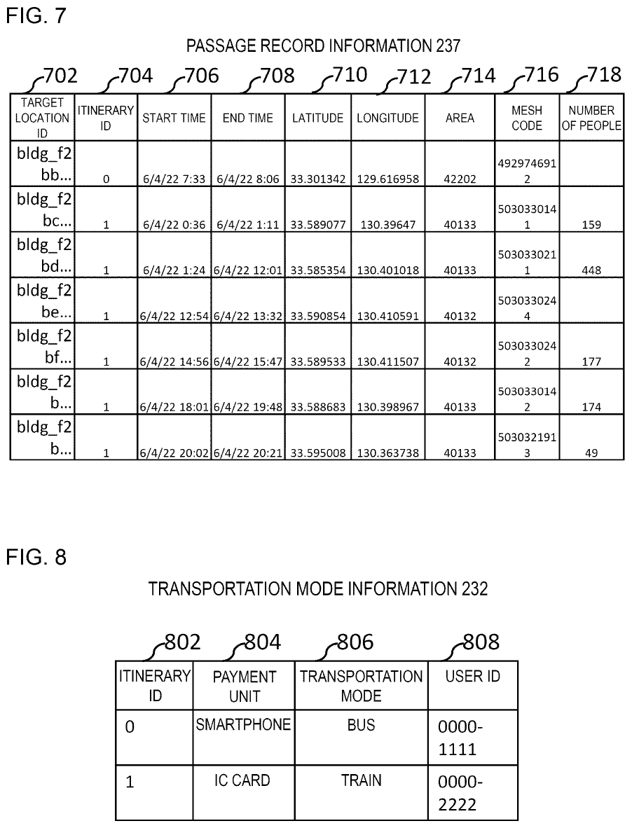

Next, the passage record information according to the embodiment of the present disclosure will be described with reference to FIG. 7.

FIG. 7 is a diagram illustrating an example of a configuration of the passage record information 237 according to the embodiment of the present disclosure. As described above, the passage record information 237 according to the embodiment of the present disclosure is information indicating a travel route that passes through a determination region for a target location defined in the spatial index 235, and is information generated by comparing the determination region for the target location defined in the spatial index 235 with a travel route of a traveler in the travel route information 231 in the people flow information generation processing 300 described with reference to FIG. 3.

As illustrated in FIG. 7, the passage record information 237 includes information on a target location ID 702, an itinerary ID 704, a start time 706, an end time 708, latitude 710, longitude 712, an area 714, a mesh code 716, and number of people 718.

The target location ID 702 is information for uniquely identifying a specific target location in a determination region through which at least one travel route passes. The itinerary ID 704 is information for uniquely specifying a travel itinerary of a travel route that passes through the determination region for the target location. The start time 706 is information indicating date and time when the travel route starts to pass through the determination region for the target location.

The end time 708 is information indicating date and time when the travel route finishes passing through the determination region for the target location.

The latitude 710 is information indicating latitude of a place through which the travel route passes through the determination region for the target location.

The longitude 712 is information indicating longitude of the place through which the travel route passes through the determination region for the target location.

The area 714 is information uniquely indicating an area through which the travel route passes through the determination region for the target location.

The mesh code 716 is information for uniquely identifying a mesh region through which the travel route passes in the determination region for the target location, when a specific area is expressed as a mesh obtained by dividing the specific area into regions having substantially the same size.

The number of people 718 is information indicating the number of people that passes through the determination region for the target location.

The people flow information indicating a people flow in the area can be generated based on the passage record information 237 illustrated in FIG. 7.

Next, the transportation mode information according to the embodiment of the present disclosure will be described with reference to FIG. 8.

FIG. 8 is a diagram illustrating an example of a configuration of the transportation mode information 232 according to the embodiment of the present disclosure. As described above, the transportation mode information 232 according to the embodiment of the present disclosure is information indicating a transportation mode used by a traveler moving in a specific area for each travel route of the traveler. In one embodiment, similarly to the travel route information 231 described above, the transportation mode information 232 may be information on a past use predetermined history of a user acquired by a transportation service provider, or may be acquired in advance from a transportation service provider and stored in the storage unit 230 of the demand prediction device 210.

As illustrated in FIG. 8, the transportation mode information 232 may include information on an itinerary ID 802, a payment unit 804, a transportation mode 806, and a user ID 808.

The itinerary ID 802 is information for uniquely identifying a specific travel itinerary.

The payment unit 804 is information indicating a unit used for payment to a transportation service during the travel itinerary.

The transportation mode 806 is information indicating a transportation mode used in the travel itinerary. The transportation mode 806 may indicate any transportation mode such as a bus, a train, walking, a car, or a taxi.

The user ID 808 is information for uniquely identifying a user in the travel itinerary.

By analyzing the transportation mode information 232 described above by a predetermined statistical analysis unit, it is possible to generate the transportation preference information indicating a priority order of transportation modes for each travel route of a traveler.

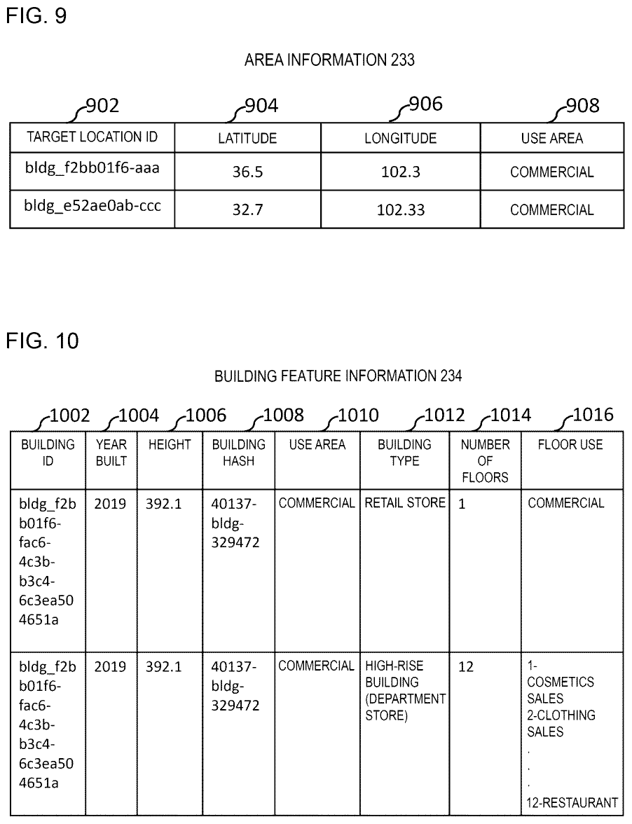

Next, the area information according to the embodiment of the present disclosure will be described with reference to FIG. 9.

FIG. 9 is a diagram illustrating an example of the area information 233 according to the embodiment of the present disclosure. As described above, the area information 233 according to the embodiment of the present disclosure is information characterizing a target location in a specific area. The area information 233 may be created based on, for example, information on a map of the area, information on urban planning related to the area, and position information acquired from a mobile device of a user, and may be stored in the storage unit 230 of the demand prediction device 210.

As illustrated in FIG. 9, the area information 233 include information on a target location ID 902, may latitude 904, longitude 906, a target location ID 908, and a use area 910.

The target location ID 902 is information for uniquely identifying a specific target location in an area.

The latitude 904 is information indicating latitude of the specific target location.

The longitude 906 is information indicating longitude of the specific target location.

The use area 908 is information indicating use (for example, commercial, administrative, or residential) of an area where a specific building is present.

As described above, by using the area information 233 according to the embodiment of the present disclosure, it is possible to predict a demand degree for each target location in a specific area.

Next, the building feature information according to the embodiment of the present disclosure will be described with reference to FIG. 10.

FIG. 10 is a diagram illustrating an example of a configuration of the building feature information 234 according to the embodiment of the present disclosure. As described above, the building feature information 234 according to the embodiment of the present disclosure is information characterizing a feature of a building in a specific area. The building feature information 234 may be created based on, for example, information on a map of the area or information on urban planning related to the area, and may be stored in the storage unit 230 of the demand prediction device 210.

As illustrated in FIG. 10, the building feature information 234 may include information on a building ID 1002, year built 1004, a height 1006, a building hash 1008, a use area 1010, a building type 1012, number of floors 1014, and a floor use 1016.

The building ID 1002 is information for uniquely identifying a specific building in a specific area. The year built 1004 is information indicating a year in which a specific building is constructed.

The height 1006 is information indicating a height of the specific building in meters.

The building hash 1008 is a hash value associated with the specific building in a spatial index.

The use area 1010 is information indicating use (for example, commercial, administrative, or residential) of an area where the specific building is present.

The building type 1012 is information indicating a type of the specific building (such as a detached house, an apartment, a retail store, or a high-rise building). The number of floors 1014 is information indicating the number of floors in the specific building.

The floor use 1016 is information indicating use (cosmetics sales, clothing sales, restaurant, or the like) for each floor in the specific building.

By using the building feature information 234 illustrated in FIG. 10, it is possible to predict a demand for each region in a building.

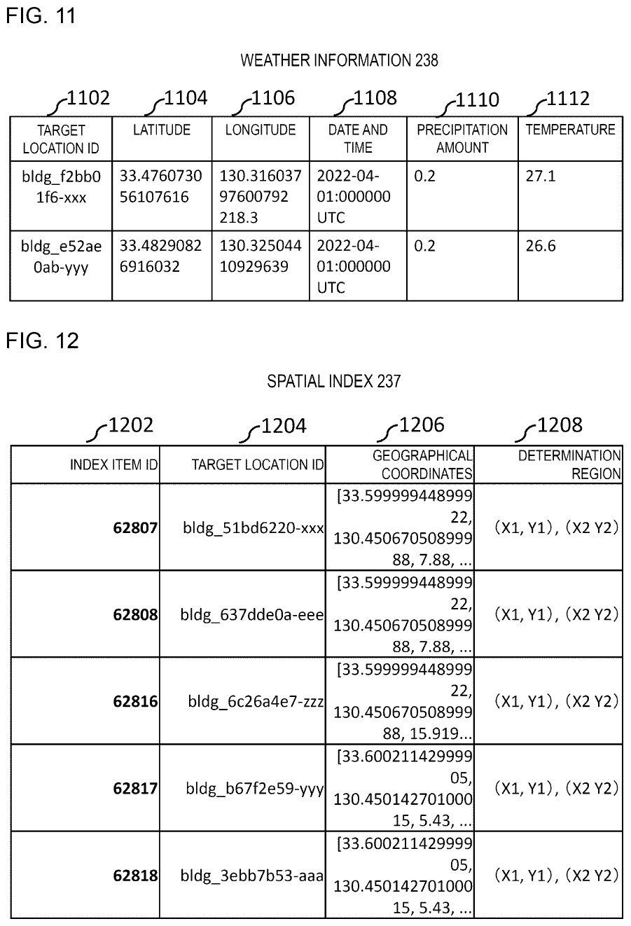

Next, the weather information according to the embodiment of the present disclosure will be described with reference to FIG. 11.

FIG. 11 is a diagram illustrating an example of a configuration of the weather information 238 according to the embodiment of the present disclosure. As described above, the weather information 238 according to the embodiment of the present disclosure is information characterizing a climate of a specific area, and may be acquired from, for example, Meteorological Agency or a public climate information database and stored in the storage unit 230.

As illustrated in FIG. 11, the weather information 238 may include information on a target location ID 1102, latitude 1104, longitude 1106, date and time 1108, a precipitation amount 1110, and a temperature 1112.

The target location ID 1102 is information for uniquely identifying a specific target location in an area. The latitude 1104 is information indicating latitude of the specific target location.

The longitude 1106 is information indicating longitude of the specific target location.

The date and time 1108 are information indicating date and time when measurement regarding the specific target location is performed.

The precipitation amount 1110 is information indicating a precipitation amount of the specific target location.

The temperature 1112 is information indicating a temperature of the specific target location.

By training the graph neural network based on the weather information 238 illustrated in FIG. 11, the graph neural network can be used to learn an influence of the weather on a demand degree and generate a more robust demand prediction.

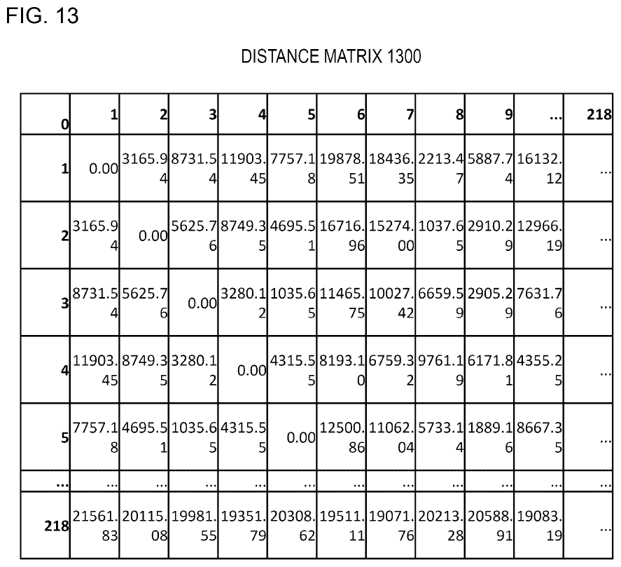

Next, the spatial index according to the embodiment of the present disclosure will be described with reference to FIGS. 12 and 13.

FIGS. 12 and 13 are diagrams illustrating examples of information in the spatial index 235 according to the embodiment of the present disclosure. As described above, the spatial index 235 according to the embodiment of the present disclosure is information indicating a space relation between target locations in a specific area, and may be generated in the people flow information generation processing 300 described above with reference to FIG. 3.

As illustrated in FIG. 12, the spatial index 235 may include information on an index item ID 1202, a target location ID 1204, geographic coordinates 1206, and a determination region 1208, and a distance matrix 1300 as illustrated in FIG. 13.

The index item ID 1202 is information for uniquely identifying a specific item in a spatial index.

The target location ID 1204 is information for uniquely identifying a specific target location in an area.

The geographic coordinates 1206 are information indicating latitude and longitude of the specific target location in the area.

The determination region 1208 is information indicating coordinates of a region (bounding box) (for example, coordinates of an upper left corner and a lower right corner of a region) having a certain size including the specific target location in the area. Although FIG. 12 illustrates two-dimensional coordinates defining the two-dimensional determination region 1208, the present disclosure is not limited thereto, and when the spatial index 235 is represented by a three-dimensional model or the like, the determination region 1208 may be three-dimensional coordinates.

As illustrated in FIG. 13, the spatial index 235 may include the distance matrix 1300. The distance matrix 1300 is a diagram illustrating Euclidean, or Manhattan distance between target locations (1, 2, and 3, . . . 218 in FIG. 13) in the spatial index 235. For example, the distance matrix 1300 indicates that the target location “1” and a handling location “2” are “3165.94” meters apart.

As described above, it is possible to predict a demand degree for each target location in a specific area based on the spatial index 235 according to the embodiment of the present disclosure illustrated in FIGS. 12 and 13 and the travel route information 231 described above.

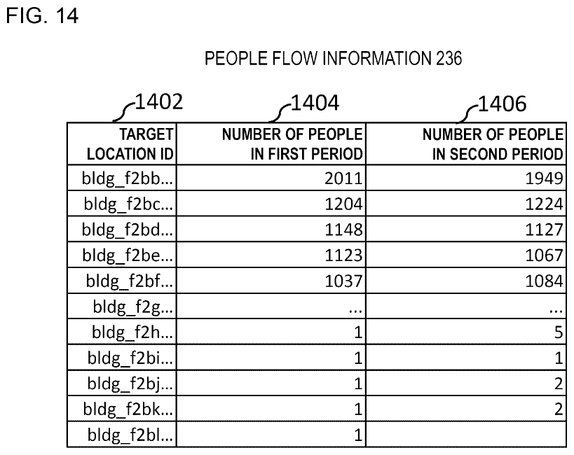

Next, the people flow information according to the embodiment of the present disclosure will be described with reference to FIG. 14.

FIG. 14 is a diagram illustrating an example of the people flow information 236 according to the embodiment of the present disclosure. As described above, the people flow information 236 according to the embodiment of the present disclosure is information indicating a people flow for each target location in a specific area. The people flow information 236 may be generated by the people flow information generation processing 300 described above with reference to FIG. 3.

As illustrated in FIG. 14, the people flow information 236 may include a target location ID 1402, number of people in first period 1404, and number of people in second period 1406.

The target location ID 1402 is information for uniquely identifying a specific target location in an area.

The number of people in first period 1404 and the number of people in second period 1406 are information indicating the number of people staying in (that is, passing through) the specific target location in a predetermined period.

The first period and the second period may be any time interval, and may be, for example, 15 minutes, 30 minutes, an hour, or a day.

By using the people flow information 236 illustrated in FIG. 14 and the area information 233 described above as the training information for training the graph neural network, the graph neural network is trained to learn, for any time interval, a correlation between the number of people staying at a target location in a specific area and a space relation of target locations, and generate a demand prediction for a target location in any area.

As described above, according to the demand prediction according to the embodiment of the present disclosure, it is possible to provide a demand prediction unit capable of generating a highly accurate prediction regarding a demand status of a specific area by training the graph neural network using the training data based on a feature of an area which is a prediction target, a demand for each time, a traveler transportation preference, and the like.

More specifically, by using a spatial index based on detailed features such as a position (latitude and longitude), a feature (the number of floors, a height, and an owned area), and an inner feature (a layout of an indoor region) of a building (a high-rise building, a station, a restaurant, a house, or the like) in a specific area and travel route information defining latitude and longitude of a travel route of a traveler, not only a rough demand prediction for an entire area but also people flow information indicating a people flow in each indoor region in the building present in the specific area can be generated.

By training the graph neural network using people flow information indicating a people flow in a specific area, area information characterizing the area, and transportation preference information indicating a transportation mode preference of a traveler, it is possible for the graph neural network to learn, for any time interval, a correlation between the number of people staying at a target location in a specific area, a space relation of target locations, and transportation preferences of a traveler, and generate a demand prediction for a target location in any area, taking into account a relation between elements that are difficult to capture by a CNN-based unit in the related art. Further, by training the graph neural network based on weather information or the like related to a specific area, it is possible to generate a demand prediction in consideration of an influence of weather on demand.

According to the highly accurate demand prediction according to the embodiment of the present disclosure, transport facilities, commercial companies, urban planning businesses, and the like can provide services that meet demands, alleviate demands, reduce a burden on transportation services, and save human resources, computing resources, and financial assets.

As described above, the demand prediction unit according to the embodiment of the present disclosure relates to the following aspects.

### (Aspect 1)

A demand prediction device including:
a processor;
a memory; and
a storage unit, in which
the storage unit stores
   first area information characterizing a target location in a first area, and
   first travel route information characterizing a travel route of a traveler moving in the first area, and
the memory includes a processing instruction for causing the processor to execute as
   an index management unit configured to apply a predetermined spatial index unit to the first area information to generate a first spatial index indicating the first area information in a hierarchical structure,
   a training information management unit configured to analyze the first spatial index and the first travel route information to generate, for a first period, first people flow information indicating a people flow in the first area,
   a model training unit configured to train a graph neural network using at least the people flow information and the first area information as training information to generate a trained demand prediction model, and
   a prediction unit configured to process, by the trained demand prediction model, second area information characterizing a target location in a second area and second people flow information indicating a people flow in the second area to generate, for a second period, demand prediction information indicating a demand degree for each target location in the second area.

### (Aspect 2)

The demand prediction device according to aspect 1, in which
the first area information includes a geographic coordinate of each target location in the first area, and
the index management unit uses an R-tree index unit as the predetermined spatial index unit to generate, based on the geographic coordinate of the target location in the first area information, the first spatial index that defines a space relation of the target location and a determination region for the target location.

### (Aspect 3)

The demand prediction device according to aspect 2, in which
the training information management unit generates the first people flow information by determining, for each target location in the first spatial index, whether the travel route of the traveler defined in the first travel route information passes through the determination region for the target location in the first period.

### (Aspect 4)

The demand prediction device according to any one of aspects 1 to 3, in which
the storage unit further includes transportation mode information indicating transportation modes used by the traveler moving in the first area for each travel route of the traveler, and
the training information management unit generates first transportation preference information indicating a priority order of transportation modes for each travel route of the traveler by analyzing the transportation mode information by a predetermined statistical analysis unit.

### (Aspect 5)

The demand prediction device according to aspect 4, in which
the model training unit
   generates people flow embedding information indicating the first people flow information in a vector format,
   generates area embedding information indicating the first area information in a vector format,
   generates transportation preference embedding information indicating the first transportation preference information in a vector format, and
   generates the trained demand prediction model by training the graph neural network based on the people flow embedding information, the area embedding information, and the transportation preference embedding information.

### (Aspect 6)

The demand prediction device according to aspect 5, in which
the model training unit
   determines a distribution characteristic characterizing a distribution of the first people flow information by analyzing the first people flow information by a Kolmogorov-Smirnov test, and
   determines, based on the determined distribution characteristic, a kernel function used to generate the people flow embedding information based on the first people flow information.

### (Aspect 7)

The demand prediction device according to any one of aspects 1 to 6, in which
the prediction unit generates the demand prediction information indicating a demand degree for each target location in the second area as a two-dimensional or three-dimensional heat map for the second period, and outputs the demand prediction information via a user interface.

### (Aspect 8)

The demand prediction device according to any one of aspects 1 to 7, in which
the storage unit further includes building feature information characterizing a feature of a building in the first area,
the first travel route information includes in-building movement information indicating an indoor region of a building that is passed through on the travel route of the traveler, and
the model training unit trains a graph neural network using the first people flow information generated based on the first travel route information including the in-building movement information and the building feature information as the training information to generate the trained demand prediction model for predicting a demand degree for each region in the building for a predetermined period.

Although embodiments of the invention have been described above, the invention is not limited to the embodiments described above, and various changes can be made without departing from the gist of the invention.

### REFERENCE SIGNS LIST

150 demand prediction application
200 demand prediction system
210 demand prediction device
220 memory
222 index management unit
224 training information management unit
226 model training unit
228 prediction unit
230 storage unit
231 travel route information
232 transportation mode information
233 area information
234 building feature information
235 spatial index
236 people flow information
237 passage record information
238 weather information
244 processor
246 input and output unit
250 communication network
260 user terminal

1. A demand prediction device comprising:
a processor;
a memory; and
a storage unit, wherein
the storage unit stores
first area information characterizing a target location in a first area, and
first travel route information characterizing a travel route of a traveler moving in the first area, and
the memory includes a processing instruction for causing the processor to execute as
an index management unit configured to apply a predetermined spatial index unit to the first area information to generate a first spatial index indicating the first area information in a hierarchical structure,
a training information management unit configured to analyze the first spatial index and the first travel route information to generate, for a first period, first people flow information indicating a people flow in the first area,
a model training unit configured to train a graph neural network using at least the people flow information and the first area information as training information to generate a trained demand prediction model, and
a prediction unit configured to process, by the trained demand prediction model, second area information characterizing a target location in a second area and second people flow information indicating a people flow in the second area to generate, for a second period, demand prediction information indicating a demand degree for each target location in the second area.

2. The demand prediction device according to claim 1, wherein
the first area information includes a geographic coordinate of each target location in the first area, and
the index management unit uses an R-tree index unit as the predetermined spatial index unit to generate, based on the geographic coordinate of the target location in the first area information, the first spatial index that defines a space relation of the target location and a determination region for the target location.

3. The demand prediction device according to claim 2, wherein
the training information management unit generates the first people flow information by determining, for each target location in the first spatial index, whether the travel route of the traveler defined in the first travel route information passes through the determination region for the target location in the first period.

4. The demand prediction device according to claim 1, wherein
the storage unit further includes transportation mode information indicating transportation modes used by the traveler moving in the first area for each travel route of the traveler, and
the training information management unit generates first transportation preference information indicating a priority order of transportation modes for each travel route of the traveler by analyzing the transportation mode information by a predetermined statistical analysis unit.

5. The demand prediction device according to claim 4, wherein
the model training unit
generates people flow embedding information indicating the first people flow information in a vector format,
generates area embedding information indicating the first area information in a vector format,
generates transportation preference embedding information indicating the first transportation preference information in a vector format, and
generates the trained demand prediction model by training the graph neural network based on the people flow embedding information, the area embedding information, and the transportation preference embedding information.

6. The demand prediction device according to claim 5, wherein
the model training unit
determines a distribution characteristic characterizing a distribution of the first people flow information by analyzing the first people flow information by a Kolmogorov-Smirnov test, and
determines, based on the determined distribution characteristic, a kernel function used to generate the people flow embedding information based on the first people flow information.

7. The demand prediction device according to claim 1, wherein
the prediction unit generates the demand prediction information indicating a demand degree for each target location in the second area as a two-dimensional or three-dimensional heat map for the second period, and outputs the demand prediction information via a user interface.

8. The demand prediction device according to claim 1, wherein
the storage unit further includes building feature information characterizing a feature of a building in the first area,
the first travel route information includes in-building movement information indicating an indoor region of a building that is passed through on the travel route of the traveler, and
the model training unit trains a graph neural network using the first people flow information generated based on the first travel route information including the in-building movement information and the building feature information as the training information to generate the trained demand prediction model for predicting a demand degree for each region in the building for a predetermined period.

9. A demand prediction system in which a demand prediction device and a user terminal are connected via a communication network, wherein
the demand prediction device includes
a processor,
a memory, and
a storage unit, and
the storage unit stores
first area information characterizing a target location in a first area, and
first travel route information characterizing a travel route of a traveler moving in the first area, and
the memory includes a processing instruction for causing the processor to execute as
an index management unit configured to apply a predetermined spatial index unit to the first area information to generate a first spatial index indicating the first area information in a hierarchical feature,
a training information management unit configured to analyze the first spatial index and the first travel route information to generate, for a first period, first people flow information indicating a people flow in the first area,
a model training unit configured to train a graph neural network using at least the people flow information and the first area information as training information to generate a trained demand prediction model, and
a prediction unit configured to process, by the trained demand prediction model, second area information characterizing a target location in a second area and second people flow information indicating a people flow in the second area to generate, for a second period, demand prediction information indicating a demand degree for each target location in the second area, and output the demand prediction information to the user terminal.

10. A demand prediction method to be executed by a demand prediction device, wherein
the demand prediction device includes
a processor,
a memory, and
a storage unit, and
the storage unit stores
first area information characterizing a target location in a first area,
building feature information characterizing a feature of a building in the first area, and
first travel route information including a travel route of a traveler moving in the first area and in-building movement information indicating an indoor region of a building that is passed through on the travel route of the traveler, and
the memory includes a processing instruction for causing the processor to execute of
a step of applying a predetermined spatial index unit to the first area information and the building feature information to generate a first spatial index indicating a building in the first area information in a hierarchical structure,
a step of analyzing the first spatial index and the first travel route information including the in-building movement information to generate, for a first period, first people flow information indicating a people flow for each building present in the first area,
a step of training a graph neural network using at least the people flow information, the first area information, and the building feature information as training information to generate a trained demand prediction model, and
a step of processing, by the trained demand prediction model, second area information characterizing a target location in a second area, second people flow information indicating a people flow in the second area, and second building feature information characterizing a feature of a building in the second area to generate, for a second period, demand prediction information indicating a demand degree for each target location and building in the second area, and output the demand prediction information.
